(19) United States
(12) Patent Application Publication
(10) Pub. No.: US 2024/0412339 A1
(43) Pub. Date: Dec. 12, 2024

(54) DENOISING AND SUPER RESOLUTION

(71) Applicant: Smiths Detection France S.A.S., Vitry Sur Seine (FR)

(72) Inventors: Najib GADI, Vitry-sur-Seine (FR); Luis TOBIAS, Vitry-sur-Seine (FR)

(21) Appl. No.: 18/696,734

(22) PCT Filed: Sep. 28, 2022
(86) PCT No.: PCT/GB2022/052446

§ 371 Date: Mar. 28, 2024

(30) Foreign Application Priority Data
Sep. 30, 2021 (GB) 2114042.1

(51) Int. Cl. G06T 5/70; G01N 23/04; G01N 23/083; G01V 5/22; G06T 3/4046; G06T 3/4053; G06T 5/60; G06T 7/00; G06V 10/25

(52) U.S. Cl. CPC G06T 5/70; G01N 23/04; G01N 23/083; G01V 5/22; G06T 3/4046; G06T 3/4053; G06T 5/60; G06T 7/0004; G06V 10/25; G01N 2223/639; G06T 2207/10116; G06T 2207/20081; G06T 2207/30108

(57) ABSTRACT

A computer-implemented method of processing one or more inspection images including a plurality of pixels includes obtaining an input inspection image generated by an inspection system configured to inspect one or more containers, wherein the inspection system is configured to inspect the container by transmission, through the container, of inspection radiation generated by an accelerator and having an angular divergence from the accelerator to an inspection radiation receiver including a plurality of detectors, the input inspection image having a higher noise, the higher noise including a Poisson-Gaussian noise whose variance is non-constant in the plurality of pixels, and a lower resolution; and processing the obtained input inspection image by applying, to the input inspection image, a trained machine learning algorithm for simultaneously increasing the lower resolution and decreasing the higher noise.

### CROSS-REFERENCE TO RELATED APPLICATIONS

The present application is a national stage entry of PCT/GB2022/052446 filed on Sep. 28, 2022, which claims the benefits of GB Patent Application No. 2114042.1 filed on Sep. 30, 2021, the contents of which are hereby incorporated by reference in their entirety.

### BACKGROUND

The disclosure relates but is not limited to a computer-implemented method of processing one or more inspection images. The disclosure also relates to a method of training a machine learning algorithm used in the computer-implemented method according to any aspects of the disclosure. The disclosure also relates but is not limited to corresponding devices or methods of producing such devices, and corresponding computer programs or computer program products.

Inspection images of containers containing cargo may be generated using penetrating radiation, such as High Energy X-rays (HEX).

In the case of HEX images, the physics behind the image generation, for example because the inspection radiation is generated by an accelerator and has an angular divergence from the accelerator to an inspection radiation receiver, implies the existence of multiple noises in the inspection images, the most prominent noise being a Poisson-Gaussian noise. The removal of the Poisson-Gaussian noise is a difficult task even more when ground truth data is not available.

In some examples, a user may want to detect, in the inspection image, objects of interest, such as a threat (such as a weapon, an explosive material or a radioactive material) or a contraband product (such as drugs or cigarettes). Detection of such objects may be difficult, as the resolution of the noisy inspection image may not be sufficient to make an informed decision. In some cases, the object may not be detected at all. In cases where the detection is not clear from the inspection images, the user may inspect the container manually, which may be time consuming for the user.

### BRIEF DESCRIPTION

Aspects and embodiments of the disclosure are set out in the appended claims. These and other aspects and embodiments of the disclosure are also described herein.

Embodiments of the disclosure enable outputting inspection images which are denoised, i.e. where undesirable noise has been removed, and which have super resolution, SR, i.e. an increase of the image size by a factor X, such as 2, 4, 8 as non-limiting examples, compared to the input image, without introducing artifacts.

Denoising and SR are two components which enhance the visual quality of inspection images for a user.

Embodiments of the disclosure use one or more Deep Learning, DL, architectures to perform joint, i.e. simultaneously, Super Resolution and Denoising.

Embodiments of the disclosure use a synthetic data generator to generate training data to generate datasets which have been synthetically modified to teach the one or more DL architectures, by lowering the resolution of input images and by increasing the noise of the input images.

Embodiments of the disclosure use a Deep Neural Network, DNN, which enhances images to simultaneously remove the noise in the images while increasing the image resolution, thereby obtaining DSR, Denoising Super Resolution.

In embodiments of the disclosure, the output DSR inspection image may be overlaid over the recently acquired HEX image, in order to display a zoomed and noise-free version of the recently acquired image to the user.

Embodiments of the disclosure use a single DNN (such as a Convolutional Neural Network, CNN) which enables both good DSR capabilities and a fast computation, the computation being at least an order of magnitude faster than standard methods such as BM3D.

In addition, after a DNN has been trained, the DNN does not need parameter tuning.

Any feature in one aspect of the disclosure may be applied to other aspects of the disclosure, in any appropriate combination. In particular, method aspects may be applied to device and computer program aspects, and vice versa.

Furthermore, features implemented in hardware may generally be implemented in software, and vice versa. Any reference to software and hardware features herein should be construed accordingly.

### BRIEF DESCRIPTION OF DRAWINGS

Embodiments of the present disclosure will now be described, by way of example, with reference to the accompanying drawings, in which:

FIG. 1 shows a flow chart illustrating an example method according to the disclosure;

FIG. 2 schematically illustrates an example system and an example device configured to implement the example method of FIG. 1;

FIG. 3A illustrates an example input inspection image according to the disclosure;

FIG. 3B illustrates an example output inspection image according to the disclosure;

FIG. 4 schematically illustrates an example method to generate training images;

FIG. 5A schematically illustrates an example processing module configured to implement the example method of FIG. 1;

FIG. 5B shows a flow chart illustrating a detail of the example method of FIG. 1; and

FIG. 6 shows a flow chart illustrating another example method according to the disclosure.

In the figures, similar elements bear identical numerical references.

### DETAILED DESCRIPTION

The disclosure discloses an example computer-implemented method of processing one or more inspection images including a plurality of pixels. In some examples, the method of any of the aspects of the disclosure may be performed on a part of the input inspection image corresponding to a zone of interest. In some examples, the input inspection image may be defined by a zone of interest in an inspection image.

The disclosure also discloses an example computer-implemented method of training a machine learning algorithm used in the processing method of any of the aspects of the disclosure.

The disclosure also discloses an example method for producing a device for processing one or more inspection images.

The disclosure also discloses corresponding devices and computer programs or computer program products.

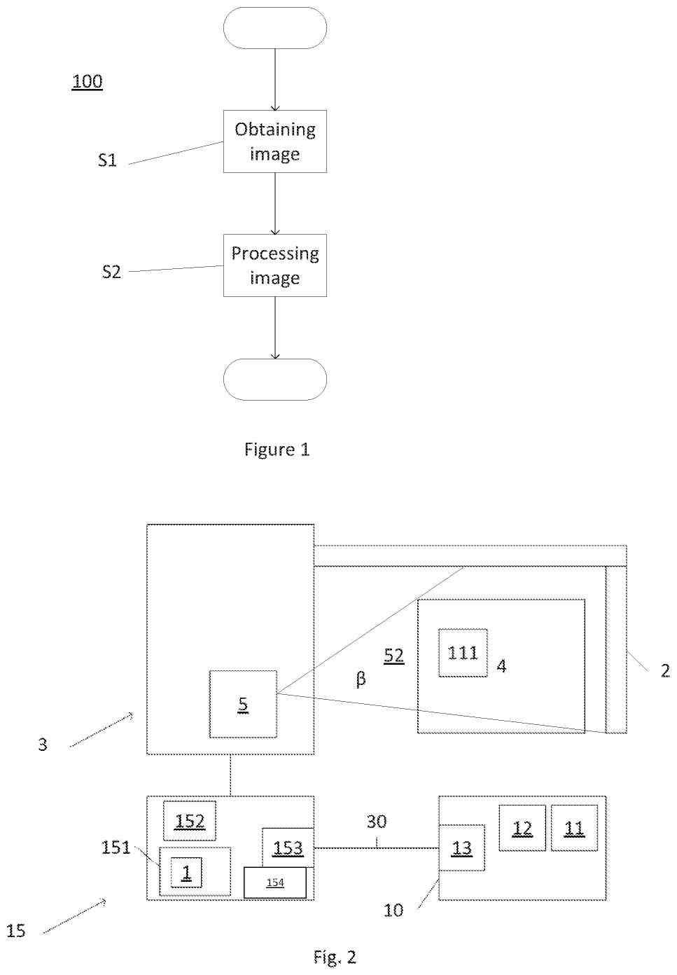

FIG. 1 shows a flow chart illustrating an example method 100 according to the disclosure.

The method 100 mainly includes:
obtaining, at S1, an input inspection image generated by an inspection system configured to inspect one or more containers; and
processing, at S2, the obtained input inspection image by applying, to the input inspection image, a trained machine learning algorithm.

The inspection system, bearing reference 3, is shown in FIG. 2. The inspection system 3 is configured to inspect a container 4 by transmission, through the container 4, of inspection radiation 52 generated by an accelerator 5. The accelerator 5 may correspond to a linear accelerator (other accelerators are envisaged) accelerating electrons on a target and generating the inspection radiation 52, i.e. X-rays, using a Bremsstrahlung effect. The inspection radiation 52 has an angular divergence p from the accelerator 5, (i.e. the target) to an inspection radiation receiver 2 including a plurality of detectors. The physics behind the image generation using the inspection radiation 52 generated by the accelerator 5 and having the angular divergence p from the accelerator 5 to the inspection radiation receiver 2 implies the existence of multiple noises in the inspection images, the most prominent noise being a Poisson-Gaussian noise. X-ray inspection images may have different levels of noise, some components of the noise, such as the Poissonian noise, are dependent of the energy settings of the accelerator 5, i.e. the energy of the inspection radiation 52. Some components of the noise, such as the Gaussian noise, are random.

FIG. 2 also shows a device 15 configurable by the method 100 to process the one or more inspection images of an object 11 located in the container 4, using the trained machine learning algorithm. The trained machine learning algorithm is also called “processing module” and bears numerical reference 1 in FIG. 2.

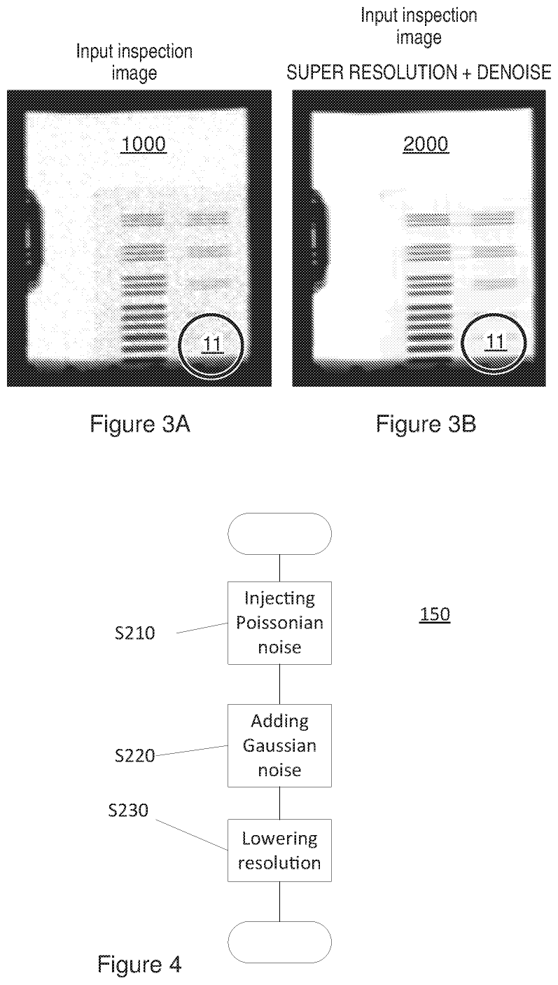

An example input inspection image 1000 is shown in FIG. 3A. The inspection image 1000 is generated using the penetrating radiation, e.g. generated by the system 3. The input inspection image 1000 has a higher noise, the higher noise including a Poisson-Gaussian noise whose variance is non-constant in the plurality of pixels, and a lower resolution.

The method 100 enables to simultaneously increase the lower resolution and decrease the higher noise, to generate an output inspection image 2000 having a resolution higher than the lower resolution and a noise lower than the higher noise, as illustrated in FIG. 3B.

As disclosed in greater detail later, the training process of the machine learning algorithm is configured to produce the processing module 1. The training process may be performed by using generated training data.

The training data may include observed or synthetic inspection images to which a Poisson-Gaussian noise has been synthetically added and of which resolution has been synthetically lowered. Each of the synthetically modified images of the training data corresponds to the input inspection image during the training process.

The processing module 1 is derived from the training data using the machine learning algorithm, and is arranged to produce the output image 2000 with the lower noise and the higher resolution.

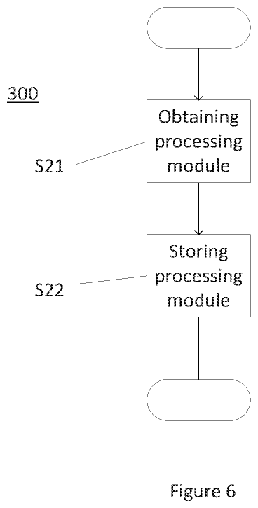

As described in FIG. 6 showing a method 300, configuration of the device 15 involves storing, e.g. at S22, the processing module 1 at the device 15. In some examples the processing module 1 may be obtained at S21 (e.g. by generating the processing module 1 using processing steps S2 of the method 100 of FIG. 1). In some examples, obtaining the processing module 1 at S21 may include receiving the processing module 1 from another data source.

The processing module 1 is arranged to process more easily the input inspection image 1000, after the processing module 1 is stored in a memory 151 of the device 15 (as shown in FIG. 2), even though the processing step of the method 100 for deriving the processing module 1 from the training data may be computationally intensive.

Once configured, the device 15 may provide the output inspection image 2000 with the lower noise and the higher resolution, by applying the processing module 1 to the input inspection image 1000, as shown in FIG. 1.

### Computer System and Detection Device

FIG. 2 schematically illustrates an example computer system 10 and the device 15 configured to implement, at least partly, the example method 100 of FIG. 1. In particular, in one embodiment, the computer system 10 executes the machine learning algorithm to generate the processing module 1 to be stored on the device 15. Although a single device 15 is shown for clarity, the computer system 10 may communicate and interact with multiple such devices. The training data may itself be obtained using a plurality of observed inspection images acquired using the inspection system 3 and/or using other, similar inspection systems and/or using other sensors and data sources, and/or a plurality of synthetic (i.e. fake) images.

The computer system 10 of FIG. 2 includes a memory 11, a processor 12 and a communications interface 13.

The system 10 may be configured to communicate with one or more devices 15, via the interface 13 and a link 30 (e.g. wireless connectivity, but other types of connectivity may be envisaged).

The memory 11 is configured to store, at least partly, data, for example for use by the processor 12. In some examples the data stored on the memory 11 may include data such as the training data (and the data used to generate the training data) and/or the machine learning algorithm.

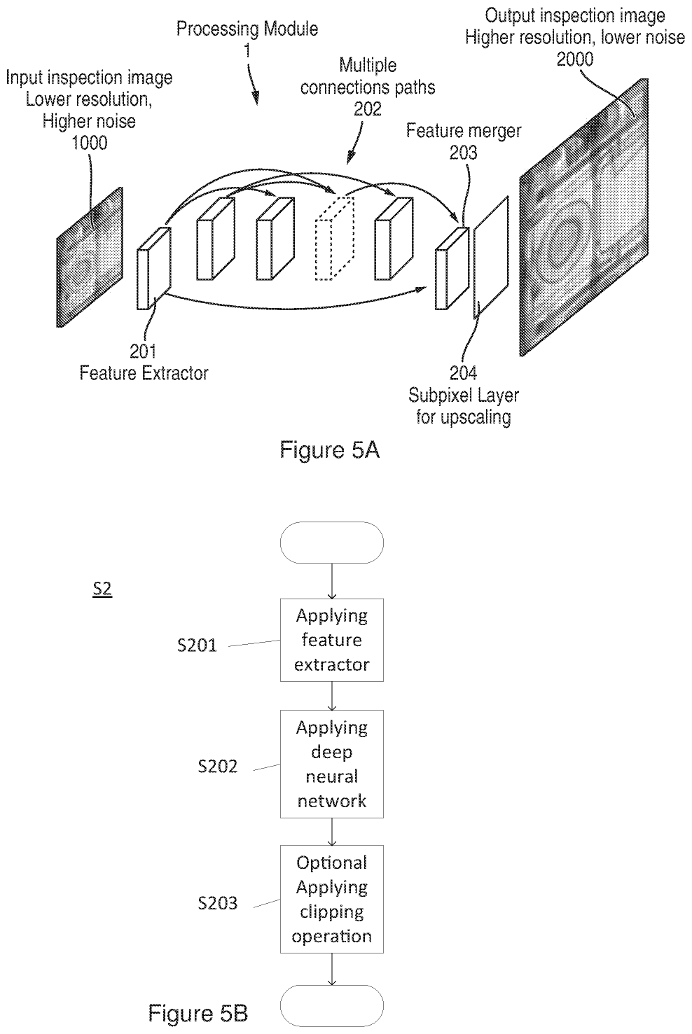

In some examples, the processor 12 of the system 10 may be configured to perform, at least partly, at least some of the steps of the method 100 of FIG. 1 and/or of the method 150 of FIG. 4 and/or of the method S2 of FIG. 5B and/or of the method 300 of FIG. 6.

The device 15 of FIG. 2 a memory 151, a processor 152 and a communications interface 153 (e.g. wireless connectivity, but other types of connectivity may be envisaged) allowing connection to the interface 13 via the link 30. In some examples, the processor 152 of the device 15 may be configured to perform, at least partly, at least some of the steps of the method 100 of FIG. 1 and/or of the method 150 of FIG. 4 and/or of the method S2 of FIG. 5B and/or of the method 300 of FIG. 6. The device 15 includes a Graphical User Interface for displaying inspection images to the user, such as the input inspection image 1000 and/or the output inspection image 2000 as illustrated in FIGS. 3A and 3B.

The inspection system 3 may be integrated into the device 15 or connected to other parts of the device 15 by wired or wireless connection.

In some examples, as illustrated in FIG. 2, the disclosure may be applied for inspection of a real container 4 containing a real object 111. At least some of the methods of the disclosure may include obtaining the input inspection images 1000, e.g. by irradiating, using penetrating radiation, one or more real containers 4 configured to contain cargo, and detecting radiation from the irradiated one or more real containers 4. The irradiating and/or the detecting may be performed using one or more inspection systems configured to inspect the real containers 4. In other words, the inspection system 3 may be used to acquire the plurality of input inspection images 1000 which may be used to generate the training data and/or to acquire the input inspection image 1000 for the processing.

### Obtaining the Training Data

Referring back to FIG. 1, the processing module 1 is generated based on the training data used as the input inspection image in steps S2. The training of the processing module 1 may be performed using the generated training data.

The processing module 1 is trained using the training data, each corresponding to an instance of an inspection image (observed or synthetic) to which a Poisson-Gaussian noise has been synthetically added to obtain a higher noise and of which resolution has been synthetically lowered. The training data is the input inspection image during the training process.

In some examples, obtaining the training data involves a synthetic data generator.

As illustrated in FIG. 4, the synthetic data generator may implement a method 150 including:
injecting, at S210, an intensity dependent Poissonian noise;
adding, at S220, random Gaussian noise; and
lowering, at S230, the resolution of the inspection image.

The Poissonian noise being dependent on an intensity of the inspection radiation.

The images may be separated in tiles of 300 pixels, with an overlap of 50 pixels between the tiles. The number of tiles used for the training may be between 1000 and 10000, as non-limiting examples.

The tiles may be down-sampled to 150×150 pixels to lower the resolution, using an average of each block of 4×4.

The images may be normalized to be in the range 0-1.

### Generating the Processing Module

Referring back to FIG. 1, the processing module 1 is built by applying the machine learning algorithm to the training data used as the input inspection images in steps S2. Any suitable machine learning algorithm may be used for building the processing module 1. For example, FIG. 5A schematically illustrates an example machine learning algorithm.

In the example of FIG. 5A, the machine learning algorithm includes a deep learning algorithm. In some examples the machine learning algorithm includes a neural network.

As illustrated in FIG. 5B with reference to FIG. 5A, applying the machine learning algorithm 1 at S2 includes:
applying, at S201, to the input inspection image, a feature extractor 201;
applying, at S202, to a feature map resulting from the application of the feature extractor 201, a deep neural network, DNN, including multiple connections paths 202, a feature merger 203, and subpixel layer 204 including a pixel shuffler.

The subpixel layer 203 is configured to perform an upscaling for obtaining an upscaled and denoised image 2000. Up-sampling of the images may use bi-linear and/or bi-cubic interpolation and/or DL models.

The method of FIG. 5B may further include an optional step of applying, at S203, to the upscaled image, a clipping operation.

In some examples, the machine learning algorithm 1 includes a loss function L, wherein the loss function L of the machine learning algorithm is such that:

$$L = α \cdot {L}^{M S - SSIM} + ( 1 - α ) \cdot {G}_{{σ}_{G}^{M}} \cdot {L}^{{l}_{1}}$$

wherein α is a weight learned by the machine learning algorithm to best map the lower resolution input inspection image to the higher resolution output inspection image,
L^{MS-SSIM} is a loss function associated with a Multi-Scale Structure Similarity Index Metric, the L^{MS-SSIM} loss function being the loss function of the synthetic data generator,
L^{l}^{₁} is a loss function associated with an l₁ normalization, the L^{l}^{₁} loss function being the loss function of the DNN, and
G_{σ}_{_{G}}_{^{M}} is function weighting the L^{l}^{₁} loss given a Gaussian kernel.

The peak signa-to-noise ratio, PSNR, and the Multi-Scale Structure Similarity Index Metric SSIM, are measured and if used as metrics of when to save a model of the machine learning algorithm, i.e. if the PSNR and the SSIM increase, the model can be saved.

The learning process is typically computationally intensive and may involve large volumes of training data. The number of inspection images in the training data may be, e.g. between 100 and 400 as non-limiting examples, and more images such as several thousands of images may be used.

In some examples, the processor 12 of system 10 may include greater computational power and memory resources than the processor 152 of the device 15. The processing module generation is therefore performed, at least partly, remotely from the device 15, at the computer system 10. In some examples, at least steps S201 and/or S202 and/or S203 of S2 are performed by the processor 12 of the computer system 10. However, if sufficient processing power is available locally then the processing module learning could be performed (at least partly) by the processor 152 of the device 15.

The machine learning step involves inferring behaviours and patterns based on the training data and encoding the detected patterns in the form of the processing module 1.

The multiple connections paths 202 include a plurality n of cells 205. Each cell 205 may have several possible configurations, while the connections between the cells 205 may remain similar. In some examples, each cell 205 may have four convolutional layers, i.e. 3×3, 3×3, 3×3, 3×3. In some examples, each cell 205 may have three convolutional layers, with a network in network, NIN, structure, e.g. 3×3, 1×1, 3×3.

The multiple connections paths 202 may include one or more Rectified Linear Units, ReLU (not shown on the figures for clarity), and/or one or more Parametric Rectified Linear Units, PReLU (not shown on the figures for clarity), located after one or more of the cells 205.

The multiple connections paths 202 may include Batch Normalization layers (not shown on the figures for clarity), after each convolution layer.

### Device Manufacture

As illustrated in FIG. 6, a method 300 of producing the device 15 configured to process inspection images may include:
obtaining, at S21, a processing module 1 generated by steps S2 of the method 100 according to any aspects of the disclosure; and
storing, at S22, the obtained processing module 1 in the memory 151 of the device 15.

The processing module 1 may be stored, at S22, in the detection device 15. The processing module 1 may be created and stored using any suitable representation, for example as a data description including data elements. Such a data description could be encoded e.g. using XML or using a bespoke binary representation. The data description is then interpreted by the processor 152 running on the device 15 when applying the processing module 1.

Alternatively, the machine learning algorithm may generate the processing module 1 directly as an executable code (e.g. machine code, virtual machine byte code or interpretable script). This may be in the form of a code routine that the device 15 can invoke to apply the processing module 1.

Regardless of the representation of the processing module 1, the processing module 1 effectively defines a decision algorithm (including a set of rules) for processing the input inspection image 1000.

After the processing module 1 is generated, the processing module 1 is stored in the memory 151 of the device 15. The device 15 may be connected temporarily to the system 10 to transfer the generated processing module (e.g. as a data file or executable code) or transfer may occur using a storage medium (e.g. memory card). In one approach, the processing module is transferred to the device 15 from the system 10 over the network connection 30 (this could include transmission over the Internet from a central location of the system 10 to a local network where the device 15 is located). The processing module 1 is then installed at the device 15. The processing module could be installed as part of a firmware update of device software, or independently.

Installation of the processing module 1 may be performed once (e.g. at time of manufacture or installation) or repeatedly (e.g. as a regular update). The latter approach can allow the processing performance of the processing module to be improved over time, as new training data becomes available.

### Applying the Processing Module to Perform Object Detection

Processing of input inspection images is based on the processing module 1.

After the device 15 has been configured with the processing module 1, the device 15 can use the processing module based on locally acquired inspection images 1000 to simultaneously denoise and upscale the inspection images 1000 to obtain the output image 2000.

In general, the processing module 1 is configured to process an inspection image 1000 generated using penetrating radiation, the inspection image 1000 including one or more features at least similar to the training data used to generate the processing module 1 by the machine learning algorithm.

### FURTHER DETAILS AND EXAMPLES

The disclosure may be advantageous but is not limited to customs and/or security applications.

The disclosure typically applies to cargo inspection systems (e.g. sea or air cargo).

The apparatus 3 of FIG. 2, acting as an inspection system, is configured to inspect the container 4, e.g. by transmission of inspection radiation through the container 4.

The container 4 configured to contain the cargo may be, as a non-limiting example, placed on a vehicle. In some examples, the vehicle may include a trailer configured to carry the container 4.

The radiation source 5 is configured to cause the inspection of the cargo through the material (usually steel) of walls of the container 4, e.g. for detection and/or identification of the cargo. Alternatively or additionally, a part of the inspection radiation may be transmitted through the container 4 (the material of the container 4 being thus transparent to the radiation), while another part of the radiation may, at least partly, be reflected by the container 4 (called “back scatter”).

In some examples, the inspection system 3 may be mobile and may be transported from a location to another location (the apparatus 3 may include an automotive vehicle).

In the source 5, electrons are generally accelerated under a voltage between 100 keV and 15 MeV.

In mobile inspection systems, the power of the X-ray source 5 may be e.g., between 100 keV and 9.0 MeV, typically e.g., 300 keV, 2 MeV, 3.5 MeV, 4 MeV, or 6 MeV, for a steel penetration capacity e.g., between 40 mm to 400 mm, typically e.g., 300 mm (12 in).

In static inspection systems, the power of the X-ray source 5 may be e.g., between 1 MeV and 10 MeV, typically e.g., 9 MeV, for a steel penetration capacity e.g., between 300 mm to 450 mm, typically e.g., 410 mm (16.1 in).

In some examples, the source 5 may emit successive x-ray pulses. The pulses may be emitted at a given frequency, between 50 Hz and 1000 Hz, for example approximately 200 Hz.

According to some examples, detectors may be mounted on a gantry, as shown in FIG. 2. The gantry for example forms an inverted “L”. In mobile inspection systems, the gantry may include an electro-hydraulic boom which can operate in a retracted position in a transport mode (not shown on the Figures) and in an inspection position (FIG. 2). The boom may be operated by hydraulic actuators (such as hydraulic cylinders). In static inspection systems, the gantry may include a static structure.

It should be understood that the inspection radiation source may include sources of other penetrating radiation, such as, as non-limiting examples, sources of ionizing radiation, for example gamma rays or neutrons. The inspection radiation source may also include sources which are not adapted to be activated by a power supply, such as radioactive sources, such as using Co60 or Cs137. In some examples, the inspection system includes detectors, such as x-ray detectors, optional gamma and/or neutrons detectors, e.g., adapted to detect the presence of radioactive gamma and/or neutrons emitting materials within the load, e.g., simultaneously to the X-ray inspection. In some examples, detectors may be placed to receive the radiation reflected by the container 4.

In the context of the present disclosure, the container 4 may be any type of container, such as a holder or a box, etc. The container 4 may thus be, as non-limiting examples a palette (for example a palette of European standard, of US standard or of any other standard) and/or a train wagon and/or a tank and/or a boot of the vehicle and/or a “shipping container” (such as a tank or an ISO container or a non-ISO container or a Unit Load Device (ULD) container).

In some examples, one or more memory elements (e.g., the memory of one of the processors) can store data used for the operations described herein. This includes the memory element being able to store software, logic, code, or processor instructions that are executed to carry out the activities described in the disclosure.

A processor can execute any type of instructions associated with the data to achieve the operations detailed herein in the disclosure. In one example, the processor could transform an element or an article (e.g., data) from one state or thing to another state or thing. In another example, the activities outlined herein may be implemented with fixed logic or programmable logic (e.g., software/computer instructions executed by a processor) and the elements identified herein could be some type of a programmable processor, programmable digital logic (e.g., a field programmable gate array (FPGA), an erasable programmable read only memory (EPROM), an electrically erasable programmable read only memory (EEPROM)), an ASIC that includes digital logic, software, code, electronic instructions, flash memory, optical disks, CD-ROMs, DVD ROMs, magnetic or optical cards, other types of machine-readable mediums suitable for storing electronic instructions, or any suitable combination thereof.

As one possibility, there is provided a computer program, computer program product, or computer readable medium, including computer program instructions to cause a programmable computer to carry out any one or more of the methods described herein. In example implementations, at least some portions of the activities related to the processors may be implemented in software. It is appreciated that software components of the present disclosure may, if desired, be implemented in ROM (read only memory) form. The software components may, generally, be implemented in hardware, if desired, using conventional techniques.

Other variations and modifications of the system will be apparent to the skilled in the art in the context of the present disclosure, and various features described above may have advantages with or without other features described above. The above embodiments are to be understood as illustrative examples, and further embodiments are envisaged. It is to be understood that any feature described in relation to any one embodiment may be used alone, or in combination with other features described, and may also be used in combination with one or more features of any other of the embodiments, or any combination of any other of the embodiments. Furthermore, equivalents and modifications not described above may also be employed without departing from the scope of the disclosure, which is defined in the accompanying claims.

1. A computer-implemented method of processing one or more inspection images comprising a plurality of pixels, the method comprising:
obtaining an input inspection image generated by an inspection system configured to inspect one or more containers, wherein
the inspection system is configured to inspect the container by transmission, through the container, of inspection radiation generated by an accelerator and having an angular divergence from the accelerator to an inspection radiation receiver comprising a plurality of detectors;
the input inspection image having a higher noise, the higher noise comprising a Poisson-Gaussian noise whose variance is non-constant in the plurality of pixels, and a lower resolution; and
processing the obtained input inspection image by applying, to the input inspection image, a trained machine learning algorithm for simultaneously increasing the lower resolution and decreasing the higher noise, to generate an output inspection image having a resolution higher than the lower resolution and a noise lower than the higher noise.

2. The method of claim 1, wherein the machine learning algorithm comprises a deep learning algorithm.

3. The method of claim 2, wherein the machine learning algorithm comprises a deep neural network, DNN.

4. The method of claim 2, wherein the machine learning algorithm is previously trained using training data as input inspection images.

5. The method of claim 4, wherein the training data is previously generated by a synthetic data generator implementing a method to generate a plurality of input inspection images, the implemented method comprising, for each inspection image:
injecting a Poissonian noise to the inspection image, the Poissonian noise being dependent on an intensity of the inspection radiation; and
adding a random Gaussian noise to the inspection image having the injected Poissonian noise.

6. The method of claim 5, wherein the training data is previously generated by the synthetic data generator further lowering a resolution of each image of the plurality of images of the generated training data.

7. The method of claim 2, wherein applying the machine learning algorithm comprises:
applying, to the input inspection image, a feature extractor; and
applying, to a feature map resulting from the application of the feature extractor, the deep neural network, DNN, the DNN comprising multiple connections paths, a feature merger, and subpixel layer comprising a pixel shuffler configured to perform an upscaling of the pixels.

8. The method of claim 7, wherein the DNN is a residual and densely connected.

9. The method of claim 7, further comprising applying, to the upscaled image, a clipping operation.

10. The method of claim 5, wherein the machine learning algorithm comprises a loss function L, wherein the loss function L of the machine learning algorithm is such that:
L=α·L^{MS-SSIM}+(1−α)·G_{σ}_{_{G}}_{^{M}}·L^{l}^{₁}
wherein α is a weight learned by the machine learning algorithm to best map the lower resolution input inspection image to the higher resolution output inspection image,
L^{MS-SSIM} is a loss function associated with a Multi-Scale Structure Similarity Index Metric, the L^{MS-SSIM} loss function being the loss function of the synthetic data generator,
L^{l}^{₁} is a loss function associated with an l₁ normalization, the L^{l}^{₁} loss function being the loss function of the DNN, and
G_{σ}_{_{G}}_{^{M}} is a function weighting the L^{l}^{₁} loss given a Gaussian kernel.

11. The method of claim 1, performed on a part of the input inspection image corresponding to a zone of interest.

12. The method of claim 1, wherein the input inspection image is defined by a zone of interest in an inspection image.

13. The method of claim 1, performed on a computer comprising a memory and a processor.

14. A computer-implemented method of training a machine learning algorithm used in any of the preceding claims, the method comprising comprising:
applying, to an input inspection image, a feature extractor, wherein the input inspection image has a higher noise, the higher noise comprising a Poisson-Gaussian noise whose variance is non-constant in the plurality of pixels, and a lower resolution; and
applying, to a feature map resulting from the application of the feature extractor, a deep neural network, DNN, comprising multiple connections paths, a feature merger, and subpixel layer comprising a pixel shuffler configured to perform an upscaling.

15. The method of claim 14, wherein the DNN is a residual and densely connected.

16. The method of claim 14, further comprising applying, to the upscaled image, a clipping operation.

17. The method of claim 14, wherein the machine learning algorithm comprises a loss function L, wherein the loss function L of the machine learning algorithm is such that:
L=α·L^{MS-SSIM}+(1−α)·G_{σ}_{_{G}}_{^{M}}·L^{l}^{₁}
wherein α is a weight learned by the machine learning algorithm to best map the lower resolution input inspection image to the higher resolution output inspection image,
L^{MS-SSIM} is a loss function associated with a Multi-Scale Structure Similarity Index Metric, the L^{MS-SSIM} loss function being the loss function of a synthetic data generator adding a Poisson-Gaussian noise to the input inspection image,
L^{l}^{₁} is a loss function associated with an l₁ normalization, the L^{l}^{₁} loss function being the loss function of the DNN, and
G_{σ}_{_{G}}_{^{M}} is a function weighting the L^{l}^{₁} loss given a Gaussian kernel.

18. The method of claim 14, wherein each input inspection image is previously generated by a synthetic data generator implementing a method to generate a plurality of input inspection images, the implemented method comprising, for each inspection image:
injecting a Poissonian noise to the inspection image, the Poissonian noise being dependent on an intensity of the inspection radiation; and
adding a random Gaussian noise to the inspection image having the injected Poissonian noise.

19. The method of claim 18, wherein the inspection image is previously generated by the synthetic data generator further lowering a resolution of each image of the plurality of images.

20. A method of producing a device configured to process inspection images, the method comprising:
obtaining a machine learning algorithm trained by the method of claim 14; and
storing the obtained trained machine learning algorithm in a memory of the device.

21-23. (canceled)
